(19) United States
(12) Patent Application Publication
(10) Pub. No.: US 2026/0064057 A1
(43) Pub. Date: Mar. 5, 2026

(54) FIXING UNIT AND IMAGE FORMING APPARATUS

(71) Applicant: CANON KABUSHIKI KAISHA, Tokyo (JP)

(72) Inventor: TATSUYOSHI SAKAMOTO, Shizuoka (JP)

(21) Appl. No.: 19/312,485

(22) Filed: Aug. 28, 2025

(30) Foreign Application Priority Data
Sep. 4, 2024 (JP) 2024-151933

(51) Int. Cl. G03G 15/20; H01F 27/255; H01F 27/28; H02K 1/02; H05B 6/14; H05B 6/36

(52) U.S. Cl. CPC G03G 15/2057; G03G 15/2064; H01F 27/255; H01F 27/28; H02K 1/02; H05B 6/145; H05B 6/365; G03G 2215/2035; G03G 2215/2048

(57) ABSTRACT

A fixing unit includes a rotary member including a conductive layer and having a tubular shape extending in a longitudinal direction, a coil configured to generate an alternating magnetic field to generate heat in the conductive layer, and a core disposed inside the rotary member and configured to guide magnetic field lines of the alternating magnetic field. The core is constituted by a plurality of divided cores aligned along the longitudinal direction. At least one of the plurality of divided cores is formed in a columnar shape having an aspect ratio of 1:5 or less between a maximum width in a cross section orthogonal to the longitudinal direction and a length in the longitudinal direction, and is made of compacted magnetic core material disposed such that a hard-magnetization axis thereof is oriented in an intersection direction intersecting the longitudinal direction.

### BACKGROUND

### Field of the Technology

The present disclosure relates to a fixing unit fixing a toner image on a recording medium and an image forming apparatus including the fixing unit.

### Description of the Related Art

According to Japanese Patent Application Laid-Open Publication No. 2014-026267, an image forming apparatus including an electro-magnetic induction heating type fixing unit is proposed. In the electro-magnetic induction heating type fixing unit, an excitation coil is wound around an outer circumference of a magnetic core, and the magnetic core and the excitation coil are inserted into a fixing film. The electric resistance of the excitation coil is set to a predetermined value and the magnetic core is divided into a plurality of portions in the longitudinal direction.

In Japanese Patent Application Laid-Open Publication No. 2014-026267, the magnetic core is made of sintered ferrite. However, for example, when the magnetic core is made of compacted magnetic core material, it is desired to suppress a core loss.

### SUMMARY

According to one aspect of the present disclosure, a fixing unit configured to fix a toner image on a recording material by heating the recording material with the toner image formed thereon includes a rotary member including a conductive layer and having a tubular shape extending in a longitudinal direction, a coil configured to generate an alternating magnetic field to generate heat in the conductive layer, and a core disposed inside the rotary member and configured to guide magnetic field lines of the alternating magnetic field. The core is constituted by a plurality of divided cores aligned along the longitudinal direction. At least one of the plurality of divided cores is formed in a columnar shape having an aspect ratio of 1:5 or less between a maximum width in a cross section orthogonal to the longitudinal direction and a length in the longitudinal direction, and is made of compacted magnetic core material disposed such that a hard-magnetization axis thereof is oriented in an intersection direction intersecting the longitudinal direction.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating a printer according to a first embodiment.

FIG. 2 is a schematic cross-sectional view illustrating a fixing unit.

FIG. 3A is a diagram illustrating an example of a conductive layer being provided over the entire surface of a fixing film 1.

FIG. 3B is a diagram illustrating an example of the conductive layer being provided on part of the surface of the fixing film.

FIG. 4 is a perspective view illustrating the fixing film, a magnetic core, and an excitation coil.

FIG. 5A is a graph showing waveforms of current flowing through the excitation coil.

FIG. 5B is a graph of BH curves each showing a relationship between a magnetic flux density and a magnetic field corresponding to a waveform of current flowing through the excitation coil.

FIG. 6A is a schematic diagram illustrating the excitation coil and a magnetic field.

FIG. 6B is a graph showing magnetic flux density distribution at a coil central axis.

FIG. 7A is a schematic diagram illustrating the excitation coil with the magnetic core inserted therein and a magnetic field.

FIG. 7B is a graph showing magnetic flux density distribution at the coil central axis.

FIG. 8A is a schematic diagram illustrating a state of a circuit being disposed in the vicinity of an end portion of the magnetic core.

FIG. 8B is a graph showing magnetic flux density distribution at the coil central axis.

FIG. 9A is a schematic diagram illustrating a heating unit and an image heating region of a sheet according to the present embodiment.

FIG. 9B is a graph showing magnetic flux density distribution at the coil central axis.

FIG. 10A is a diagram illustrating a direction of a hard-magnetization axis when a divided core is compressed in an X-direction.

FIG. 10B is a diagram illustrating a direction of a hard-magnetization axis when a divided core is compressed in a Y-direction.

FIG. 11A is a diagram illustrating how eddy current flows when a magnetic flux passes through compressed and insulation-coated iron powder.

FIG. 11B is a diagram illustrating how eddy current flows when a magnetic flux passes through iron powder compressed in a direction different from the compression direction in FIG. 11A.

FIG. 11C is a diagram illustrating how eddy current flows when a magnetic flux passes through two adjacent iron powder particles.

FIG. 12 is a diagram of a divided core as viewed from a cross-sectional direction.

FIG. 13 is a diagram illustrating a magnetic flux passing direction when a plurality of divided cores are arranged.

FIG. 14A is a diagram of a divided core according to a second embodiment as viewed from a cross-sectional direction.

FIG. 14B is a perspective view illustrating the divided core manufactured by being compressed.

FIG. 15A is a diagram illustrating a state of the plurality of divided cores being arranged such that orientations of cross sections of adjacent divided cores are aligned.

FIG. 15B is a diagram illustrating a state of the plurality of divided cores being arranged such that orientations of cross sections of adjacent divided cores are not aligned.

### DESCRIPTION OF THE EMBODIMENTS

### First Embodiment

### Image Forming Apparatus

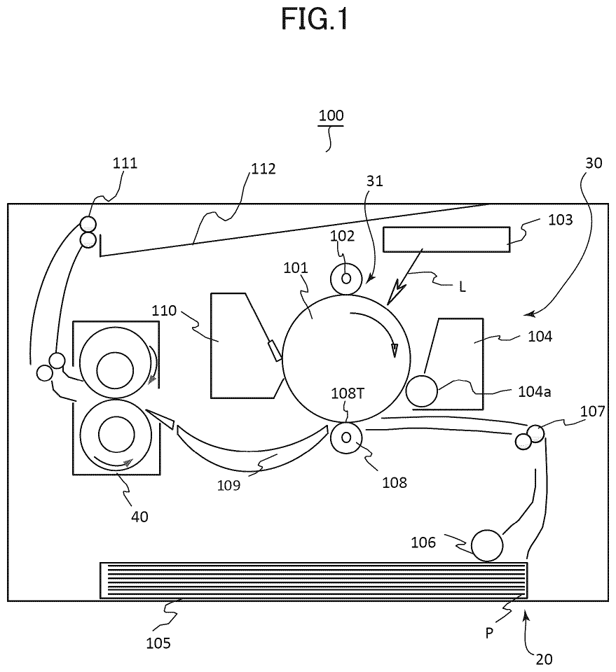

A first embodiment will be described below with reference to the drawings. FIG. 1 is a schematic configuration diagram of an image forming apparatus 100 according to the present embodiment. The image forming apparatus 100 of the embodiment is an electrophotographic system laser beam printer for forming monochrome toner images. It should be noted that the image forming apparatus includes a printer, a copying machine, a facsimile, and a multifunction machine, and is an apparatus forming an image on a sheet used as a recording medium based on image information input from an external PC or image information read from a document. The image forming apparatus may be coupled with, in addition to a main body having an image forming function, auxiliary equipment such as an option feeder, an image reading apparatus, and a sheet processing apparatus. In that case, an entire system coupled with such equipment is also a type of the image forming apparatus.

As illustrated in FIG. 1, the image forming apparatus 100 includes a sheet feeding unit 20 feeding a loaded sheet and an image forming unit 30 forming an image on a fed sheet. The image forming apparatus 100 further includes a fixing unit 40 fixing an image transferred to a sheet and a sheet discharge roller pair 111 capable of discharging the sheet to a sheet discharge tray 112.

When an image forming command is output to the image forming apparatus 100, an image formation process by the image forming unit 30 is started based on image information input from an external computer or the like connected to the image forming apparatus 100. The image forming unit 30 includes a process unit 31, a laser scanner 103, and a transfer roller 108. The process unit 31 includes a photosensitive drum 101 rotating in an arrow direction, and a charge roller 102, a developing unit 104 and a cleaning unit 110 disposed along the photosensitive drum 101. The developing unit 104 includes a developing roller 104a supplying toner to the photosensitive drum 101. The process unit 31 may be configured as a cartridge attachable to and detachable from the apparatus body of the image forming apparatus 100.

The laser scanner 103 emits laser light toward the photosensitive drum 101 based on input image information. At this time, the photosensitive drum 101 is charged by the charge roller 102 in advance, and an electrostatic latent image is formed on the photosensitive drum 101 by the emitted laser light. Thereafter, the electrostatic latent image is developed by the developing roller 104a to form a monochrome toner image on the photosensitive drum 101.

In parallel with the above-described image forming process, a sheet P is fed from the sheet feeding unit 20. The sheet feeding unit 20 includes a cassette 105 attached to and drawably supported by the apparatus body of the image forming apparatus 100, and the cassette 105 supports the sheet P. The sheet P supported by the cassette 105 is fed by a pickup roller 106. Examples of the sheet P include paper such as a printing paper and an envelope, plastic films such as an overhead projector (OHP) sheet, and cloth.

Skewing of the sheet P fed by the pickup roller 106 is corrected by a registration roller pair 107. The sheet P is conveyed by the registration roller pair 107 at a predetermined conveyance timing toward a transfer nip 108T formed by the photosensitive drum 101 and the transfer roller 108. Then, the toner image on the photosensitive drum 101 is transferred to the sheet P by an electrostatic load bias applied to the transfer roller 108. Remaining toner on the photosensitive drum 101 is collected by the cleaning unit 110.

The sheet P with the toner image transferred thereon is subjected to predetermined heat and pressure by the fixing unit 40, whereby the toner is melted and fixed (fixation). The sheet P having passed through the fixing unit 40 is discharged to the sheet discharge tray 112 by the sheet discharge roller pair 111.

### Fixing Unit

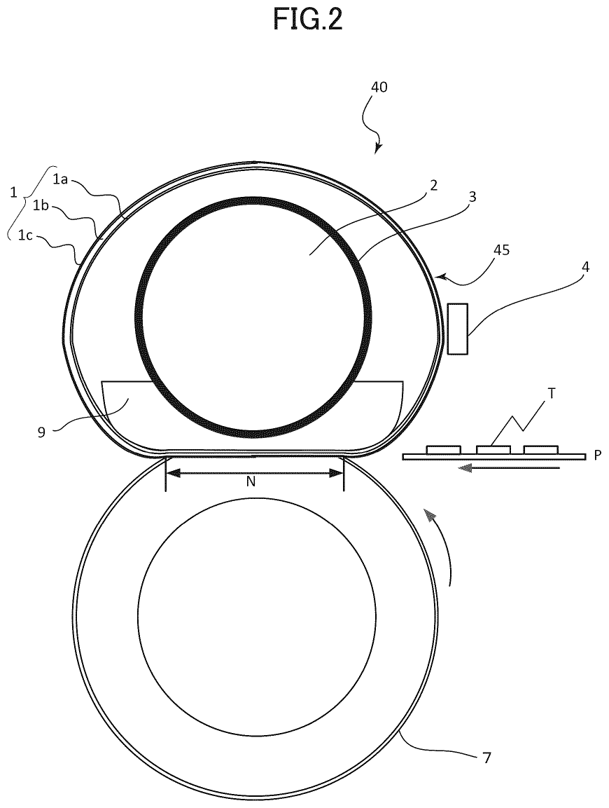

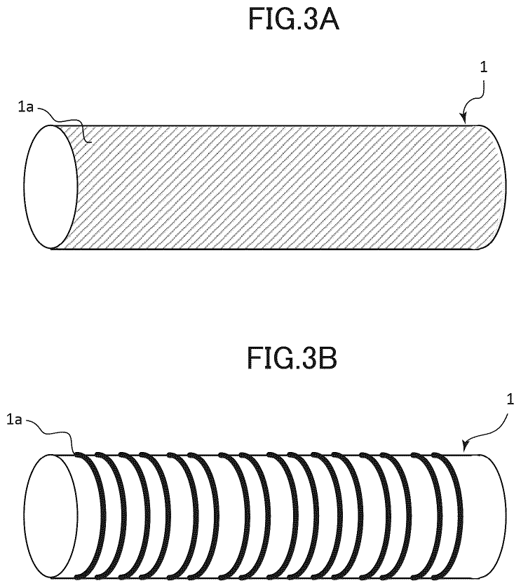

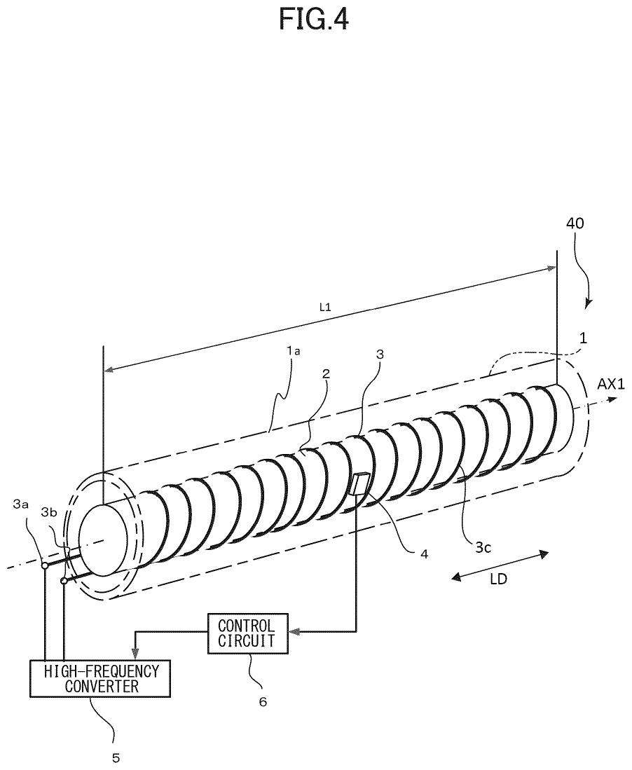

Next, a configuration of the fixing unit 40 will be described with reference to FIG. 2 to 5B. FIG. 2 is a schematic cross-sectional view illustrating the fixing unit 40. FIG. 3A is a diagram illustrating an example of a conductive layer 1a being provided over the entire surface of a fixing film 1, and FIG. 3B is a diagram illustrating an example of the conductive layer 1a being provided on part of the surface of the fixing film 1. FIG. 4 is a perspective view illustrating the fixing film 1, a magnetic core 2, and an excitation coil 3.

As illustrated in FIG. 2, the fixing unit 40 includes the fixing film 1 as a rotary member having a tubular shape, the magnetic core 2, the excitation coil 3, a film guide 9 as a member forming a nip portion to be in contact with an inner surface of the fixing film 1, and a pressure roller 7 as an opposed member. The fixing film 1, the magnetic core 2, the excitation coil 3, and the film guide 9 constitute a heating unit 45 heating the sheet P. The pressure roller 7 forms a fixing nip portion N together with the film guide 9 with interposition of the fixing film 1. The fixing unit 40 heats and pressurizes the sheet P while conveying the sheet P carrying a toner image T with the fixing nip portion N, thereby fixing the toner image T on the sheet P.

The film guide 9 is pressed against the pressure roller 7 via the fixing film 1 at a pressing force of about 50 N to 100 N (about 5 kgf to about 10 kgf) in total by a bearing portion and a biasing portion (both not illustrated). The pressure roller 7 is rotated and driven in an arrow direction by a drive source (not illustrated), and a rotational force acts on the fixing film 1 by a frictional force at the fixing nip portion N, whereby the fixing film 1 rotates in accordance with the rotation of the pressure roller 7. The film guide 9 also has a function of guiding the inner surface of the fixing film 1, and is made of heat-resistant resin such as polyphenylene sulfide (PPS).

The fixing film 1 includes a conductive layer 1a (base layer) made of metal having a diameter (outer diameter) of 10 to 100 mm, an elastic layer 1b formed on an outer side of the conductive layer 1a, and a surface layer 1c (release layer) formed on an outer side of the elastic layer 1b. The fixing film 1 has a flexibility. It should be noted that the conductive layer 1a may be provided over the entire surface of the fixing film 1 as illustrated in FIG. 3A, or may be provided in a ring shape at part of the surface of the fixing film 1 as illustrated in FIG. 3B. An alternating magnetic field is formed by high-frequency current flowing through the excitation coil 3 to be described below, and the conductive layer 1a generates heat by electromagnetic induction heating.

As illustrated in FIGS. 2 and 4, a temperature detection unit 4 is disposed in the vicinity of the surface of the fixing film 1, and the temperature detection unit 4 is provided to detect the surface temperature of the fixing film 1. In the embodiment, the temperature detection unit 4 is composed of a non-contact type thermistor.

The magnetic core 2 and the excitation coil 3 are disposed inside the fixing film 1. The excitation coil 3 is connected with a high-frequency converter 5, and the high-frequency converter 5 supplies high-frequency current to the excitation coil 3 via power supply contact portions 3a and 3b. It should be noted that, in Japan, the frequency range for use in electromagnetic induction heating is specified to a range from 20.05 kHz to 100 kHz by the Regulation for Enforcement of the Radio Act. In addition, since a loss of a switching element increases when the frequency of current supplied in a power source component is low, the frequency of current supplied to the excitation coil 3 by the high-frequency converter 5 is preferably high.

A control circuit 6 is electrically connected to the high-frequency converter 5 and the temperature detection unit 4, and the control circuit 6 controls the high-frequency converter 5 based on a temperature detected by the temperature detection unit 4. In the embodiment, the control circuit 6 performs a frequency modulation control on the high-frequency converter 5 in a region of a use frequency band of 50 kHz to 100 kHz. Accordingly, the fixing film 1 is heated by electromagnetic induction heating while being controlled such that the surface temperature thereof becomes a predetermined target temperature (about 150° C. to 200° C.).

The magnetic core 2 as a core has a circular cylinder shape and is disposed substantially at the center inside the fixing film 1 by a fixing portion (not illustrated). The magnetic core 2 has a function of guiding magnetic field lines (magnetic flux) of the alternating magnetic field generated by the excitation coil 3 into the fixing film 1 to form a path (magnetic path) of the magnetic field lines. The material of the magnetic core 2 is preferably a material having a small hysteresis loss and a high relative magnetic permeability, for example, a ferromagnetic body made of an oxide or an alloy material having a high permeability such as sintered ferrite, ferrite resin, noncrystalline alloy (amorphous alloy), or permalloy.

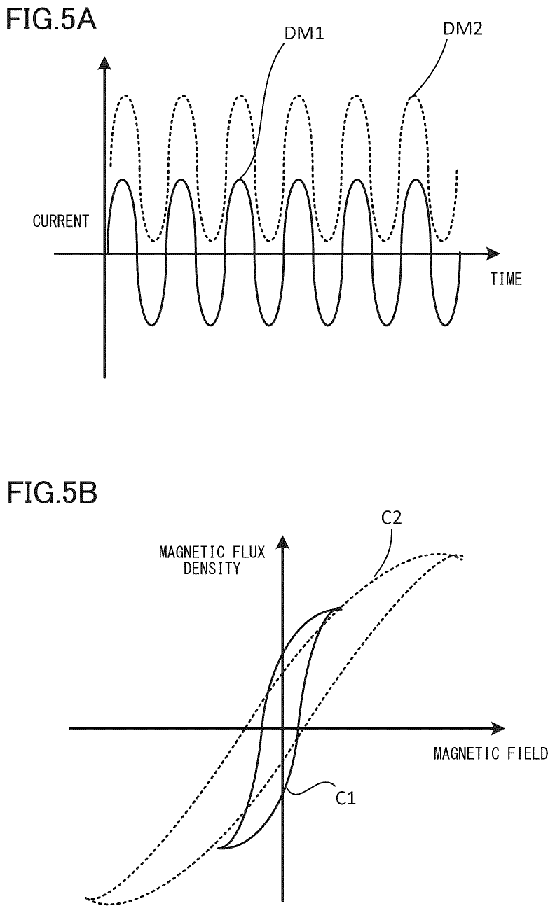

FIG. 5A is a graph showing waveforms of current flowing through the excitation coil 3, and FIG. 5B is a graph of BH curves each showing a relationship between a magnetic flux density and a magnetic field corresponding to a waveform of current flowing through the excitation coil 3. The vertical axis of FIG. 5A and the vertical axis of FIG. 5B correspond to each other, showing that when the current value of FIG. 5A falls within a range between the upper and lower limit values of the magnetic flux density of FIG. 5B, saturation does not occur and availability is ensured.

The excitation coil 3 as a coil is supplied with the above-described high-frequency current by the high-frequency converter 5. The waveform of current flowing through the excitation coil 3 varies depending on the difference in a drive method adopted for the high-frequency converter 5, and thus it is necessary to select a magnetic core using a material suitable for the drive method. In FIG. 5A, the solid line indicates a current waveform when the high-frequency converter 5 is driven by a first drive method DM1, and the dashed line indicates a current waveform when the high-frequency converter 5 is driven by a second drive method DM2. In FIG. 5B, the solid line indicates a case where a first magnetic core C1 is used, and the dashed line indicates a case where a second magnetic core C2 is used. The first drive method DM1 and the second drive method DM2 differ from each other, and the first magnetic core C1 and the second magnetic core C2 differ from each other.

The solid line in FIG. 5A indicating the first drive method DM1 is a current waveform of the current flowing through the excitation coil 3 with the center at 0 A. As can be seen from FIG. 5A and FIG. 5B, both the first magnetic core C1 and the second magnetic core C2 are fully available in regions without the magnetic flux density being saturated. As the first drive method DM1, a circuit system such as a full-bridge inverter system is generally conceivable.

The dashed line (current waveform) in FIG. 5A indicating the second drive method DM2 always has a positive value (current), showing a waveform obtained by offsetting the current waveform of the first drive method DM1 upward. As illustrated in FIG. 5A and FIG. 5B, in a case where the second magnetic core C2 is selected in the second drive method DM2, they are fully available in a region without the magnetic flux density being saturated. On the other hand, when the first magnetic core C1 is selected in the second drive method DM2, the first magnetic core C1 is saturated because the limit of a magnetic flux density, that is, a saturation flux density exists within the range of magnetic flux changes corresponding to changes in drive current. Therefore, it is difficult to use the first magnetic core C1 in the second drive method DM2. As the second drive method DM2, a circuit system such as an active clamp system is generally conceivable.

In general, in the second drive method DM2, the number of components constituting a circuit can be reduced and the circuit can be downsized, as compared to the first drive method DM1. In the embodiment, the excitation coil 3 is driven by the second drive method DM2. Therefore, for the excitation coil 3, it is necessary to use the second magnetic core C2 having a relatively high magnetic flux density, instead of the first magnetic core C1 having a low magnetic flux density.

In addition, when magnetic permeability is low, there is a possibility that the loss of the magnetic core increases, heat is generated, and a rated temperature cannot be satisfied. Therefore, a core with high magnetic permeability and high saturation magnetic flux density is preferred as a material of the magnetic core. In general, a magnetic core made of compacted magnetic t core material produced by compressing iron powder has a higher saturation magnetic flux density than a magnetic core made of ferrite or the like. For this reason, preferably, a magnetic core made of compacted magnetic core material to be described below is used for the magnetic core 2.

It has been confirmed that, in a case where high-frequency alternating current in 21 kHz to 100 kHz band flows through the excitation coil 3, the loss of ferrite is small in the vicinity of a range of 20 kHz to 50 kHz, but the loss of the magnetic core made of compacted magnetic core material is small in a range of 50 kHz to 100 kHz. Since the range of 50 kHz to 100 kHz is used in the embodiment, the magnetic core is preferably made of compacted magnetic core material with a low loss. Based on the above, in the embodiment, the second magnetic core C2 is used as the magnetic core 2, and the high-frequency converter 5 is driven by the second drive method DM2.

It is desirable that the cross-sectional area of the magnetic core 2 is as large as possible to the extent that the magnetic core 2 can be accommodated in a hollow portion of the fixing film 1. In the embodiment, the diameter of the magnetic core 2 is 5 mm to 20 mm, and a length L1 (see FIG. 4) in a longitudinal direction LD of the magnetic core 2 is 10 mm to 100 mm. It should be noted that the shape of the magnetic core 2 is not limited to the circular cylinder shape, but may be a rectangular cylinder shape. Further, by arranging 10 to 30 magnetic cores 2 side by side in the longitudinal direction LD to form a magnetic path, the durability of the magnetic cores 2 against an impact or the like is improved as compared with a configuration provided with one magnetic core having a length corresponding to 10 to 30 magnetic cores. It can be said that the longitudinal direction LD of the magnetic core 2 is parallel to the longitudinal direction of the fixing film 1, and the fixing film 1 extends in the longitudinal direction LD. The longitudinal direction LD is parallel to the generatrix direction of the fixing film 1, and the longitudinal direction LD may be referred to as the generatrix direction of the fixing film 1.

The excitation coil 3 is formed, for example, by helically winding a copper wire having a diameter of 1 to 3 mm and coated with heat-resistant polyamide imide around the magnetic core 2 by about 10 to 100 turns. The excitation coil 3 includes a helical portion 3c wound around a coil central axis AX1 extending parallel to the longitudinal direction LD, and the magnetic core 2 is disposed in the helical portion 3c. Depending on the insulation design, the excitation coil 3 may be formed of an enamel wire, a flat wire, or the like, instead of a wire coated with heat-resistant polyamide imide. In the embodiment, the number of turns of the excitation coil 3 is 20 to 50. Since the excitation coil 3 is wound around the magnetic core 2 in a direction intersecting the longitudinal direction LD, an alternating magnetic field can be generated in a direction parallel to the longitudinal direction LD by applying high-frequency current to the excitation coil 3.

It should be noted that the excitation coil 3 does not need to be wound directly around the magnetic core 2. The helical portion 3c of the excitation coil 3 may be disposed inside the fixing film 1 such that the coil central axis AX1 is parallel to the longitudinal direction LD, and the magnetic core 2 may be disposed in the helical portion 3c. For example, a configuration in which a bobbin with the excitation coil 3 helically wound around is provided inside the fixing film 1 and the magnetic core 2 is disposed inside the bobbin is also conceivable.

According to the heat generation principle, heat generation efficiency is highest when the coil central axis AX1 of the excitation coil 3 is parallel to the longitudinal direction LD. However, in a case where the parallelism of the coil central axis AX1 with respect to the longitudinal direction LD is shifted, “the amount of magnetic flux penetrating the circuit in parallel” slightly decreases, and the heat generation efficiency decreases accordingly, but there is no practical problem with an inclination only by a few degrees. That is, the coil central axis AX1 of the helical portion 3c of the excitation coil 3 does not necessarily have to be parallel to the longitudinal direction LD, but only needs to extend along the longitudinal direction LD.

### Heat Generation Principle of Fixing Film

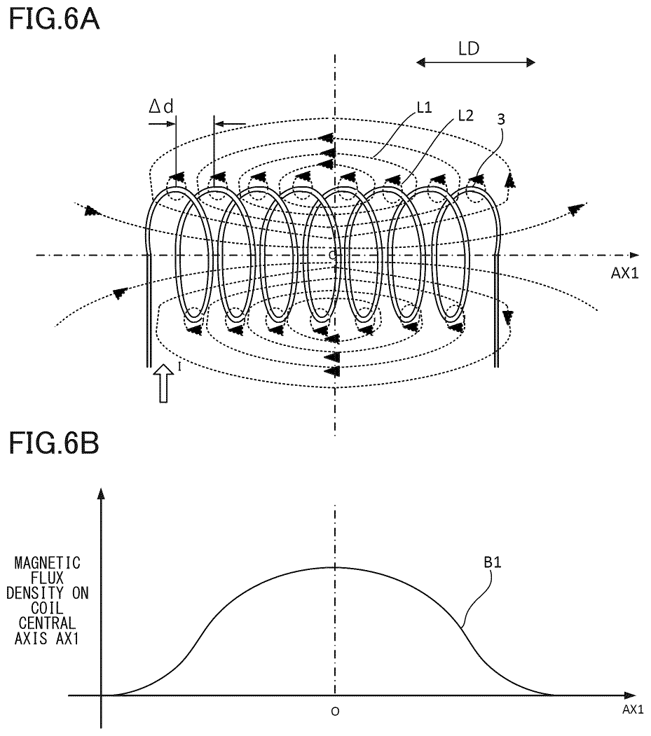

First, the shapes of magnetic field lines will be described. The description will be made using a magnetic field shape of a general air-core solenoid coil. FIG. 6A is a schematic diagram of the excitation coil 3 as an air-core solenoid coil (for better visibility, the number of turns is reduced and the shape is simplified in FIG. 6A) and a magnetic field. The excitation coil 3 has a shape with a finite-length and gaps Δd, and carries high-frequency current. The directions of the magnetic field lines are of at a moment when the current increases in an arrow direction I. Most of the magnetic field lines pass through the center of the excitation coil 3 and are connected around the circumference while leaking from the gaps Δd. FIG. 6B is a graph showing magnetic flux density distribution at the coil central axis AX1. As indicated by a curve B1 in the graph, the magnetic flux density is highest at a part of the excitation coil 3 corresponding to a center 0 and become low at ends of the excitation coil 3. This is because the magnetic field line (e.g., L1) leaks out of the gap Δd of the excitation coil 3. A near-coil circulating magnetic field L2 is also formed around the excitation coil 3. It can be said that the near-coil circulating magnetic field L2 passes through an undesirable path for efficient heating of the fixing film 1.

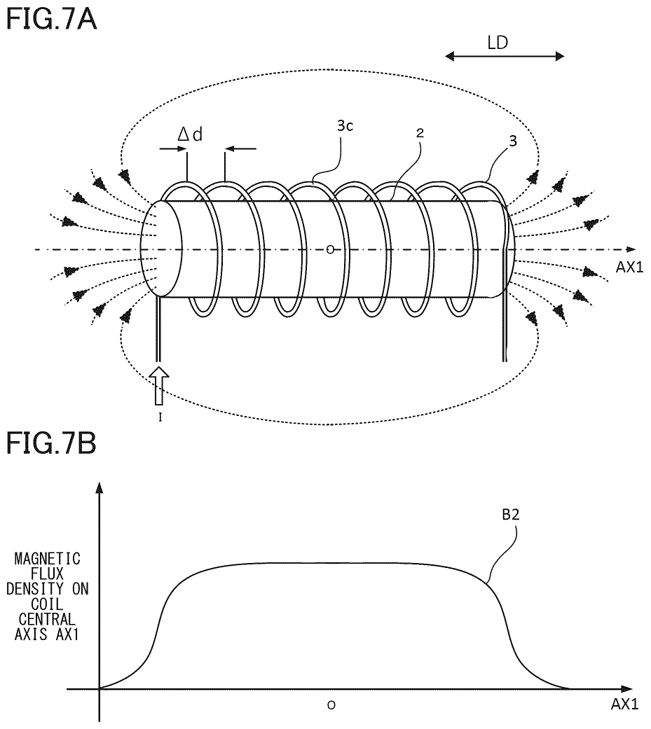

FIG. 7A is a schematic diagram illustrating the excitation coil 3 with the magnetic core 2 inserted therein and a magnetic field. As in FIG. 6A, FIG. 7A illustrates a moment when the current increases in the arrow direction I. The magnetic core 2 has a function of guiding magnetic field lines generated by the excitation coil 3 inward to form a magnetic path. The magnetic core 2 of the first embodiment does not have an annular shape, but has a circular cylinder shape having both end portions in the longitudinal direction LD. Therefore, most of the magnetic field lines are concentrated in a central magnetic path of the excitation coil 3 and form an open magnetic path having a shape of diffusing at the end portions of the magnetic core 2 in the longitudinal direction LD. As compared to FIG. 6A illustrating the air-core solenoid coil, with the excitation coil 3 with the magnetic core 2 inserted therein illustrated in FIG. 7A, the leakage of the magnetic field lines at the gaps Δd of the excitation coil 3 is significantly reduced, and the magnetic field lines coming out of both poles form an open magnetic path having a shape with the magnetic field lines being connected far away from the outer circumference. FIG. 7B is a graph showing magnetic flux density distribution at the coil central axis AX1. As indicated by a curve B2 on the graph, the magnetic flux density of excitation coil 3 with the magnetic core 2 inserted therein is less attenuated at the end portions of the excitation coil 3 and show a substantially trapezoidal shape, as compared to the curve B1 in FIG. 6B.

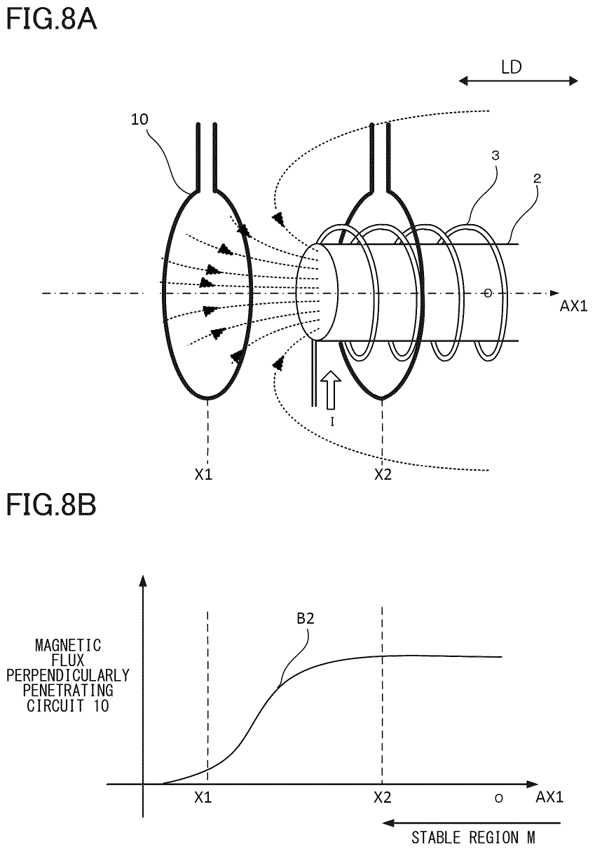

The heat generation principle of the fixing film 1 conforms to Faraday's law. Faraday's law states that “when a magnetic field in a circuit is changed, an induced electromotive force of causing current to flow through the circuit is generated, and the induced electromotive force is proportional to the time change in magnetic flux perpendicularly penetrating the circuit”. Consideration is made on a case where the excitation coil 3 and a circuit 10 larger in diameter than the magnetic core 2 are placed near an end portion of the magnetic core 2 in the excitation coil 3 illustrated in FIG. 8A, and high-frequency alternating current flows through the excitation coil 3. When high-frequency alternating current flows through the excitation coil 3, an alternating magnetic field (a magnetic field changing in magnitude and direction over time) is formed around the excitation coil 3. At this time, the induced electromotive force generated in the circuit 10 is proportional to the time change in the magnetic flux perpendicularly penetrating the circuit 10 according to Faraday's law in accordance with the following equation (1).

$$V = - N \frac{ΔΦ}{Δ t} \qquad Equation ( 1 )$$

V: Induced electromotive force
N: Number of turns of coil
ΔΦ/Δt: Change in magnetic flux perpendicularly penetrating the circuit over a very small time Δt

That is, when the time change in the vertical components of the magnetic field lines when high-frequency alternating current flows through the excitation coil 3 to generate an alternating magnetic field increase, the induced electromotive force generated in the circuit 10 increases, and current flows in a direction canceling the change in the magnetic flux in the circuit 10. In other words, when the current flows through the circuit 10 as a result of generating the alternating magnetic field, the change in the magnetic flux is canceled out, resulting in a magnetic field line shape different from that when a static magnetic field is formed. The induced electromotive force V tends to increase as the frequency of the alternating current is higher (i.e., Δt is smaller).

Therefore, the electromotive force that can be generated with a predetermined amount of magnetic flux differs greatly between a case where low-frequency alternating current of 50 to 60 Hz flows through the excitation coil and a case where high-frequency alternating current of 21 kHz to 100 kHz flows through the excitation coil. When the frequency of alternating current is set to a high frequency, a high electromotive force can be generated even with a small magnetic flux. Therefore, setting the frequency of alternating current to a high frequency can generate a large amount of heat in a magnetic core with a small cross-sectional area, and thus is very effective to generate a large amount of heat in a small fixing unit. This is similar to the fact that a transformer can be downsized by increasing the frequency of alternating current. For example, for a transformer used in a low frequency band (50 to 60 Hz), it is necessary to increase a magnetic flux @ by an amount of high Δt, and to increase the cross-sectional area of a magnetic core. On the other hand, for a transformer used in a high frequency band (kHz), it is possible to reduce a magnetic flux by an amount of small Δt and to design the magnetic core 2 to have a small cross-sectional area.

In order to generate an induced electromotive force in the circuit 10 with high efficiency by an alternating magnetic field, it is necessary to make a design such that more vertical components of the magnetic field lines pass through the circuit 10. However, in an alternating magnetic field, it is necessary to consider the effect of a diamagnetic field when an induced electromotive force is generated in the coil, resulting in a complicated phenomenon. In order to design the fixing unit 40 of the embodiment, designing can be promoted using a simpler physical model by discussing the shape of magnetic field lines in a static magnetic field state without induced electromotive force being generated. That is, by optimizing the shape of magnetic field lines in a static magnetic field, the fixing unit 40 capable of generating an induced electromotive force with high efficiency in an alternating magnetic field can be designed.

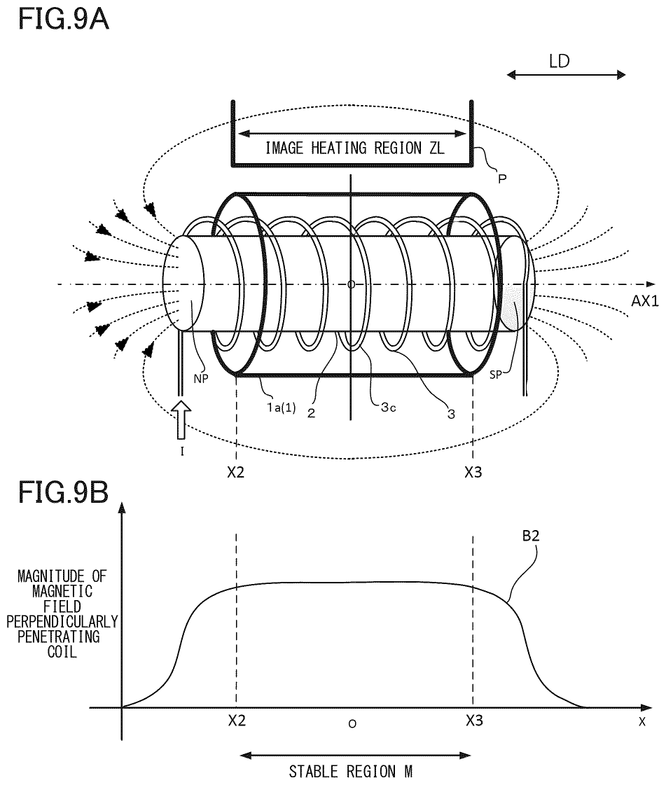

FIG. 8B is a graph showing magnetic flux density distribution at the coil central axis AX1. In considering a case where a static magnetic field (a magnetic field not changing over time) is formed by flowing direct current through the excitation coil 3, the magnetic flux perpendicularly penetrating the circuit 10 increases as indicated by the curve B2 when the circuit 10 is placed at a position X2 in FIG. 8A as compared to the magnetic flux when the circuit 10 is placed at a position X1. At the position X2 in FIG. 8A, almost all the magnetic field lines bound to the magnetic core 2 are contained in the circuit 10. In a stable region M in a positive X-axis direction with respect to the position X2, the magnetic flux perpendicularly penetrating the circuit 10 is saturated and maximized. The same applies to the opposite end portion, and FIG. 9A is a schematic diagram illustrating a heating unit 45 and an image heating region ZL of the sheet P according to the embodiment. FIG. 9B is a graph showing magnetic flux density distribution at the coil central axis AX1 in FIG. 9A. As shown in the magnetic flux density distribution in FIG. 9B, in the stable region M from the position X2 to a position X3 at the opposite end portion, the magnetic flux perpendicularly penetrating the circuit 10 is saturated and stable. As illustrated in FIG. 9A, the stable region M exists within a region with the magnetic core 2 being present.

As illustrated in FIG. 9A, in the magnetic field line configuration in the embodiment, the fixing film 1 can be covered in a region from the position X2 to the position X3 when a static magnetic field is formed. Then, a magnetic field line shape in which the magnetic flux passes outside the fixing film 1 from a magnetic pole NP as a first end of the magnetic core 2 to a magnetic pole SP as a second end is designed. Then, the image of the sheet P as a recording material is heated using the stable region M.

Therefore, in the first embodiment, the length of the magnetic core 2 in the longitudinal direction LD at least for forming a magnetic path needs to be made longer than the maximum image heating region ZL of the sheet P. As a more preferable configuration, the lengths of both the magnetic core 2 and the excitation coil 3 in the longitudinal direction LD are made longer than the maximum image heating region ZL. This makes it possible to heat the toner image on the sheet P uniformly up to the end portions. In addition, the length of the fixing film 1 in the longitudinal direction LD needs to be made longer than the maximum image heating region ZL. In the embodiment, when the solenoid magnetic field illustrated in FIG. 9A is formed, the two magnetic poles NP and SP need to be located outside the maximum image heating region ZL in the longitudinal direction of the magnetic core 2. This makes it possible to generate heat uniformly in the range of the image heating region ZL.

In the embodiment, the magnetic core 2 is longer than the helical portion 3c of the excitation coil 3 in the longitudinal direction LD and protrudes from both ends of the helical portion 3c. The magnetic core 2 and the helical portion 3c are disposed across the entire stable region M as the heating region of the fixing film 1 in the longitudinal direction LD. That is, the magnetic core 2 and the helical portion 3c protrude outward from the both end faces of the fixing film 1 in the longitudinal direction LD. Accordingly, the heat generation amount over the entire region of the fixing film 1 in the longitudinal direction LD can be stabilized.

### Manufacturing Method and Disposing Method of Divided Cores

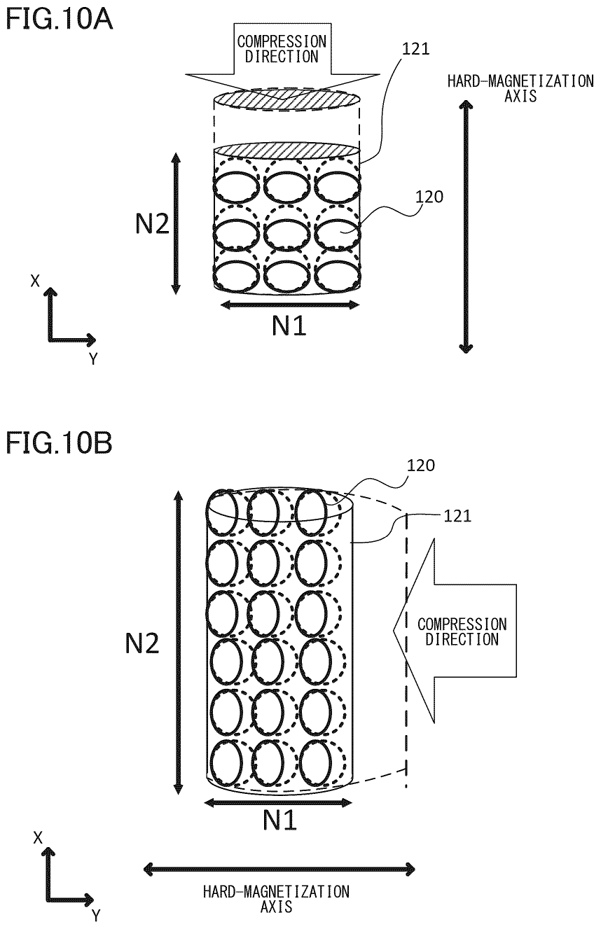

Next, a manufacturing method and a disposing method of a plurality of divided cores 121 constituting the magnetic core 2 will be described with reference to FIG. 10A to FIG. 13. FIG. 10A is a diagram illustrating a direction of a hard-magnetization axis when a divided core 121 is compressed in an X-direction, and FIG. 10B is a diagram illustrating a direction of a hard-magnetization axis when the divided core 121 is compressed in a Y-direction.

The magnetic core 2 of the embodiment includes the plurality of divided cores 121. Each of the divided cores 121 is made of compacted magnetic core material, and is manufactured by compression-molding and annealing an insulation-coated iron powder of about 20 μm in a mold. That is, the divided core 121 made of compacted magnetic core material is a compacted powder consisting of insulation-coated iron powder. By making the magnetic core 2 with the plurality of divided cores 121, the magnetic core 2 is less likely to be damaged by an external impact and has an improved durability as compared to a case of the magnetic core 2 as an integral part without being divided. It should be noted that the plurality of divided cores 121 in the embodiment are disposed without gaps between each other, but are not limited to thereto. For example, the magnetic core 2 may be configured such that the plurality of divided cores 121 are disposed with slight gaps between each other, and these plurality of divided cores 121 are integrated with a holder.

In FIG. 10A and FIG. 10B, the iron powder used to manufacture the divided core 121 is schematically illustrated as iron powder 120, the iron powder 120 and the divided core 121 before compression are indicated by dashed lines, and the iron powder 120 and the divided core 121 after compression are indicated by solid lines. In addition, the divided core 121 illustrated in FIG. 10A is formed in a circular cylinder shape extending in the X-direction. Therefore, when the divided core 121 is compressed from above (from the downstream side in the X-direction) as illustrated in FIG. 10A, the divided core 121 is compressed in the X-direction, and the iron powder 120 is crushed from a perfect circle shape into to an elliptical shape in the X-direction. In the following, the diameter of the circular cross section of the divided core 121 is referred to as a diameter N1, the height of the divided core 121, that is, the length of the generatrix is referred to as a length N2. The diameter N1 is the maximum width in the cross section perpendicular to the longitudinal direction LD of the divided core 121.

In FIG. 10B, the divided core 121 is compressed in the Y-direction, that is, from the circumferential side of the divided core 121 having a circular cylinder shape. As a result, in FIG. 10B, the divided core 121 is compressed such that the diameter N1 of the circular cross-section is reduced, and the iron powder 120 is crushed from a perfect circle shape to an elliptical shape in the Y-direction.

When the aspect ratio (the diameter N1:the length N2) of the divided core 121 after compression is equal to or less than 1:5, processing is easier by compressing the divided core 121 in the length direction of the divided core 121 (the direction of the length N2, that is, the X-direction), as illustrated in FIG. 10A. On the other hand, when the aspect ratio (the diameter N1:the length N2) of the divided core 121 after compression is larger than 1:5, processing is easier by compressing the divided core 121 in the radial direction of the divided core 121 (the direction of the diameter N1, that is, the Y-direction), as illustrated in FIG. 10B.

Here, an easy-magnetization axis refers to a direction in which a magnetic flux easily passes in a magnetic body, and a hard-magnetization axis refers to a direction in which a magnetic flux is less likely to pass in the magnetic body. Similar to the relationship among resistance value, current, and heat generation amount in an electric circuit, when the amount of passing current (magnetic flux) is the same, a heat generation amount increases as a resistance value increases (that is, the magnetic flux is less likely to pass). Therefore, in a case where a direction of the magnetic flux passing through the divided core 121 coincides with the hard-magnetization axis of the divided core 121, the heat generation amount of the divided core 121 is larger than in a case of the easy-magnetization axis. That is, the loss of the divided core 121 increases. In order to suppress the core loss, the divided core 121 is preferably disposed such that the magnetic flux flows in a direction different from the hard-magnetization axis, and more preferably, the magnetic flux flows in the divided core 121 in the same direction as the easy-magnetization axis.

There are three possible reasons why an easy-magnetization axis and a hard-magnetization axis are formed. These three reasons are typical examples, and an easy-magnetization axis and a hard-magnetization axis can be formed for other reasons.

The first reason is the effect of saturation magnetostriction density. When σ is a magnitude of a compression stress and λ is a saturation magnetostriction constant, a magnitude K of the uniaxial anisotropic energy is expressed by the following equation (2).

$$K = \frac{3}{2} λσ \qquad Equation ( 2 )$$

K: Uniaxial magnetization anisotropic energy
λ: Saturation magnetostriction constant
σ: Compressive stress

The uniaxial anisotropy energy is energy indicating how much energy stability the direction of magnetization in a magnetic body has with respect to a specific axis (easy-magnetization axis), and is energy required when the magnetic body is magnetized in the direction of the easy-magnetization axis. Therefore, it can be said that easy-magnetization axes are easily aligned by increasing the compressive stress σ or using a material having a large saturation magnetostriction constant 2. This is synonymous with the fact that hard-magnetization axes are easily aligned.

Further, when the saturation magnetostriction constant λ is a positive value, the hard-magnetization axis is formed in the same direction as the compression direction of the divided core 121, and when the saturation magnetostriction constant λ is a negative value, the hard-magnetization axis is formed in a direction perpendicular to the compression direction. Since the iron powder used in the embodiment has a saturation magnetostriction constant λ of a positive value, the hard-magnetization axis is formed in the same direction as the compression direction.

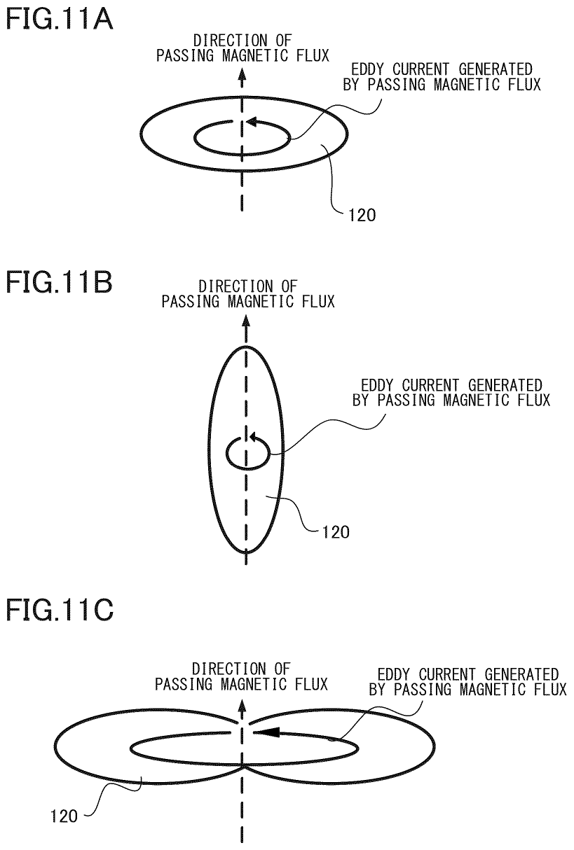

The second reason is the effect of eddy current due to crushing of particles of the iron powder 120. FIG. 11A illustrates how eddy current flows when a magnetic flux passes through the iron powder 120 compressed and insulation-coated, and FIG. 11B illustrates how eddy current flows when a magnetic flux passes through the iron power 120 compressed in a direction different from the compression direction in FIG. 11A. The cross-sectional area with respect to the magnetic flux passing direction of the iron powder 120 illustrated in FIG. 11A is larger than that of the iron powder 120 illustrated in FIG. 11B. Therefore, the iron powder 120 illustrated in FIG. 11A generates more eddy current than the iron powder 120 illustrated in FIG. 11B.

When eddy current flows, a magnetic flux is generated in a direction preventing a passing magnetic flux (a direction opposite to the dashed arrow in FIG. 11A). That is, since it becomes difficult for the passing magnetic flux to flow due to the generation of more eddy current, a hard-magnetization axis is formed in the same direction as the compression direction.

The third reason is the effect of eddy current due to contact between particles. FIG. 11C illustrates a cross section of the iron powder and how eddy current flows when a magnetic flux passes through, in a case where two adjacent particles come into contact with each other and the insulation coating is peeled off when the iron powder is compressed at the time of manufacturing the divided core. When the adjacent particles of the iron powder come into contact with each other and the insulation coating is peeled off, the particles lose the insulation therebetween and become one large particle. In addition, although not illustrated, even in a case where the insulation coating between the particles is peeled off and a point contact occurs, when many particles come into contact to form an electrically closed-loop circuit, eddy current is generated by a magnetic flux passing through the closed loop.

As in the second reason, when eddy current is generated, a magnetic flux is generated in a direction preventing a magnetic flux, an eddy current loss occurs, and apparent magnetic permeability is reduced, and thus the compression direction of the divided core 121 becomes a hard-magnetization axis. As described above, the larger the cross-sectional area of the iron powder perpendicular to the magnetic flux passing direction or the area of the electrically closed loop is, the more eddy current flows and the less magnetic flux flows.

As described above for the three typical reasons, in the embodiment, a hard-magnetization axis is generated in the same direction as the compression direction of the divided core 121.

That is, in a case of the compression direction illustrated in FIG. 10A, a hard-magnetization axis is oriented in the X-direction. In a case where the plurality of divided cores 121 having a circular cylinder shape are disposed in the longitudinal direction LD to form the magnetic core 2, the magnetic flux passes through the direction of the coil central axis AX1 and the longitudinal direction LD of the fixing film 1. For this reason, the magnetic flux passing direction becomes a hard-magnetization axis, making it difficult for the magnetic flux to pass through the magnetic core 2, resulting in a large heat generation amount of the magnetic core 2.

On the other hand, in a case of the compression direction illustrated in FIG. 10B, a hard-magnetization axis is oriented in the Y-direction. That is, the hard-magnetization axis is perpendicular to the direction of the magnetic flux passing through the magnetic core 2. From the above, in order to suppress a core loss and heat generation in the magnetic core 2, it is necessary to compress the divided core 121 in the compression direction illustrated in FIG. 10B and make the hard-magnetization axis perpendicular to the magnetic flux passing direction.

As described above, in a case where the aspect ratio of the divided core (the diameter N1:the length N2) is equal to or less than 1:5, the divided core is molded in the compression direction illustrated in FIG. 10A for ease of processing in an ordinary manufacturing method. For this reason, when the plurality of divided cores are disposed in the longitudinal direction LD, the hard-magnetization axis is oriented in the magnetic flux passing direction.

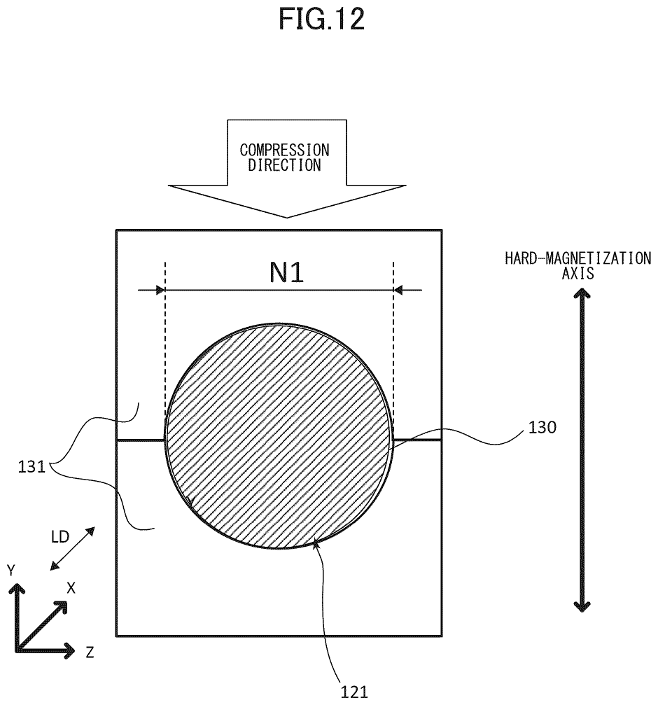

Therefore, in the embodiment, the divided core 121 having a circular cylinder shape (columnar shape) is manufactured as described below. FIG. 12 is a diagram of the divided core 121 as viewed from a cross-sectional direction. As illustrated in FIG. 12, in the embodiment, two molds 131 each having a semicircular recess are used to compress and mold the divided core 121 in the arrow direction in the drawing. Accordingly, a cross section 130 of the divided core 121 has a circular shape and the direction of the hard-magnetization axis is the Y-direction, even when the aspect ratio (the diameter N1:the length N2) is equal to or less than 1:5.

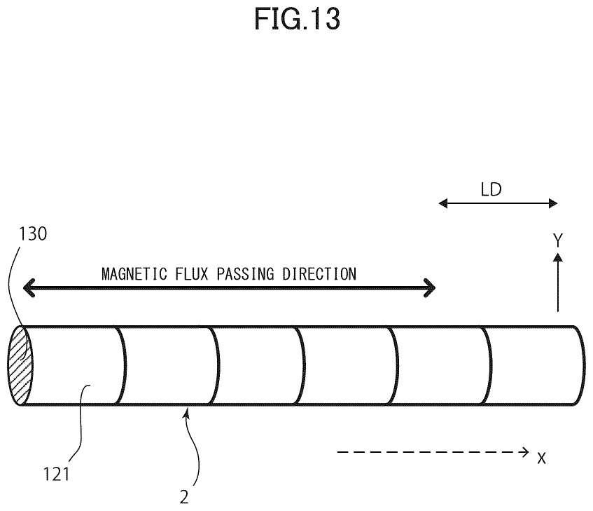

FIG. 13 is a diagram illustrating a magnetic flux passing direction when the plurality of divided cores 121 are arranged. The magnetic flux passes in the X-direction illustrated in FIG. 13. In the embodiment, the plurality of divided cores 121 manufactured by the method described with reference to FIG. 12 are aligned in the X-direction parallel to the longitudinal direction LD to form the magnetic core 2. At this time, the hard-magnetization axis of each of the divided cores 121 is oriented in the Y-direction as an orthogonal direction orthogonal to the longitudinal direction LD. Since the magnetic flux passing direction is the X-direction, the arrangement relationship is such that the hard-magnetization axis is perpendicular to the magnetic flux passing direction, and the core loss and the heat generation of the magnetic core 2 can be suppressed. That is, the fixing unit 40 highly efficient and capable of suppressing the core loss and the heat generation of the magnetic core 2 can be obtained. In addition, since the magnetic core 2 is made of compacted magnetic core material, a saturation magnetic flux density can be improved as compared to the magnetic core 2 made of sintered ferrite or the like.

### Second Embodiment

Next, a second embodiment of the present disclosure will be described. The second embodiment is configured with a change made to the shape of the divided core of the first embodiment. Therefore, for components similar to those in the first embodiment, illustrations thereof will be omitted, or description will be made using the same reference signs in the drawings.

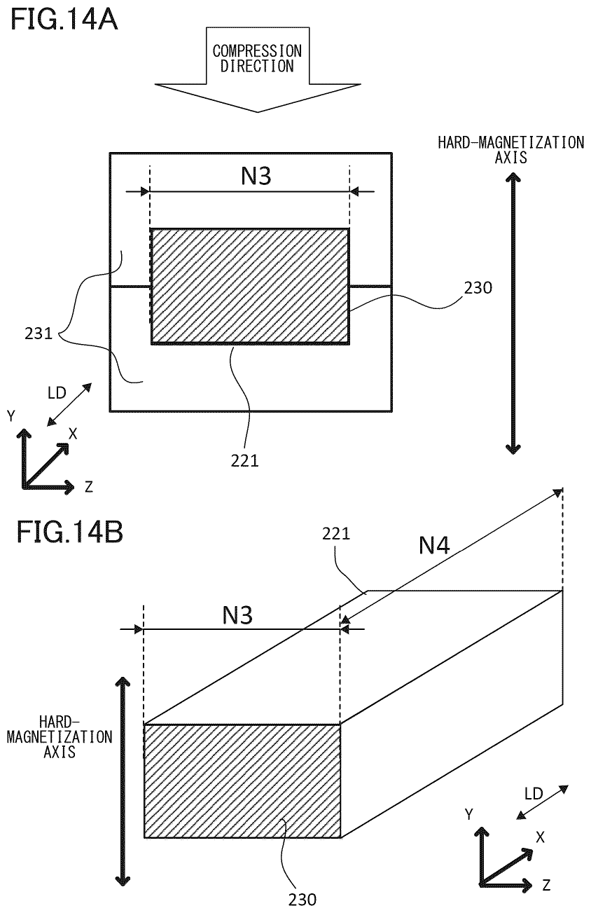

FIG. 14A is a diagram of a divided core 221 according to the second embodiment as viewed from a cross-sectional direction, and FIG. 14B is a perspective view illustrating the divided core 221 manufactured by being compressed. In the present embodiment, the divided core 221 having a substantially prismatic shape is manufactured as described below. As illustrated in FIG. 14A, in the embodiment, two molds 231 each having a rectangular recess are used to compress and mold the divided core 221 in the arrow direction in the drawing. Accordingly, as illustrated in FIG. 14B, a cross section 230 of the divided core 221 has a rectangular shape and the direction of the hard-magnetization axis is the Y-direction, even when the aspect ratio (a maximum width N3: a length N4) is equal to or less than 1:5. The maximum width N3 is the maximum width in a cross section of the divided core 221 perpendicular to the longitudinal direction LD.

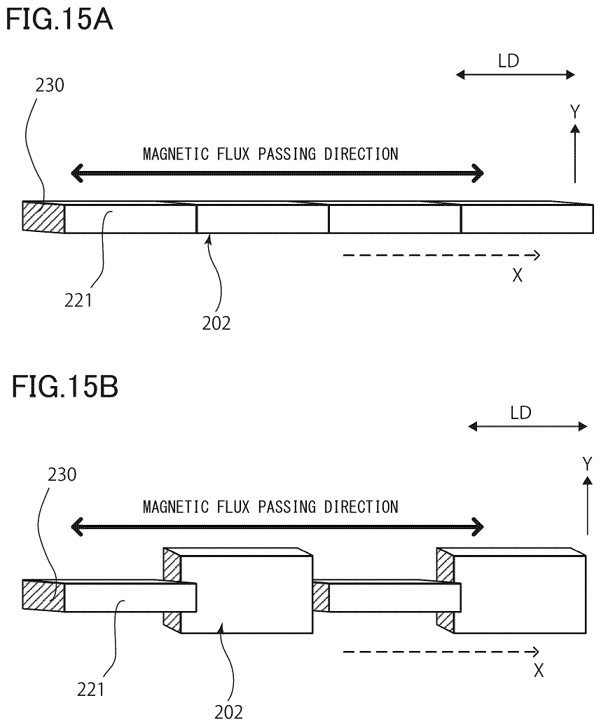

FIG. 15A and FIG. 15B are diagrams each illustrating a magnetic flux passing direction when the plurality of divided cores 221 are arranged. In FIG. 15A, the plurality of divided cores 221 are arranged such that the orientations of cross sections 230 of the adjacent divided cores 221 are aligned. In FIG. 15B, the plurality of divided cores 221 are arranged such that the orientations of the cross sections 230 of the adjacent divided cores 221 are shifted by 90°.

The magnetic flux passes in the X-direction illustrated in FIG. 15A and FIG. 15B. The plurality of divided cores 221 manufactured by the method described with reference to FIG. 14A are arranged in the X-direction to form the magnetic core 202. At this time, the hard-magnetization axis of each of the divided cores 221 is oriented in the Y-direction. Since the magnetic flux passing direction is the X-direction, the arrangement relationship is such that the hard-magnetization axis is perpendicular to the magnetic flux passing direction, and the core loss and the heat generation of the magnetic core 202 can be suppressed. That is, the fixing unit 40 highly efficient and capable of suppressing the core loss and the heat generation of the magnetic core 202 can be obtained.

It should be noted that the magnetic flux is more likely to pass through the magnetic core 202 and the core loss can be reduced when the plurality of divided cores 221 are arranged in the arrangement method illustrated in FIG. 15A rather than when the plurality of divided cores 221 are arranged in the arrangement method illustrated in FIG. 15B. For this reason, the magnetic core 202 illustrated in FIG. 15A is more preferable.

Further, in a case where the plurality of divided cores 221 are disposed side-by-side, the divided cores 221 are arranged in a holder (or cover) to prevent the divided cores 221 from moving. At this time, when the plurality of divided cores 221 are arranged with the cross sections 230 not aligned as illustrated in FIG. 15B, gaps may be generated between the divided cores 221 and the holder, and the magnetic core 202 may be damaged due to vibration, or the like, resulting in reduction in durability.

Therefore, the plurality of divided cores 221 are arranged side by side such that the cross sections 230 are aligned as illustrated in FIG. 15A and the holder is formed to fit the shape of the divided cores 221, whereby the gap between each of the divided cores 221 and the holder can be reduced. This makes the magnetic core 202 less likely to vibrate, and thus the durability of the magnetic core 202 can be improved.

### Other Embodiments

In all of the above-described embodiments, the plurality of divided cores constituting the magnetic core have the same configuration, but are not limited thereto. That is, at least one of the divided cores constituting the magnetic core needs to be disposed with its hard-magnetization axis oriented in an intersection direction intersecting the longitudinal direction LD. In other words, some of the plurality of divided cores constituting the magnetic core may be disposed with their hard-magnetization axes oriented in the longitudinal direction LD.

In all of the above-described embodiments, the helical portion 3c of the excitation coil 3 is disposed inside the fixing film 1, but is not limited to thereto. For example, the helical portion 3c of the excitation coil 3 may be disposed outside the fixing film 1. That is, the excitation coil 3 may be disposed anywhere as long as it can form an alternating magnetic field to cause the conductive layer 1a of the fixing film 1 to generate heat.

In all of the above-described embodiments, the divided cores 121 and 221 are disposed with their hard-magnetization axes oriented in the Y-direction perpendicular to the longitudinal direction LD, but are not limited thereto. For example, the divided cores 121 and 221 may be disposed with their hard-magnetization axes oriented in a direction intersecting the longitudinal direction LD.

In all of the above-described embodiments, the fixing film 1 is made of a thin film, but is not limited to thereto. For example, instead of the fixing film 1, a belt thicker than a film may be used.

In all of the above-described embodiments, the magnetic cores 2 and 202 are respectively composed of the divided cores 121 and 221 aligned in the longitudinal direction LD, but are not limited thereto. For example, the alignment direction of the divided cores 121 and 221 may be a direction along the longitudinal direction LD.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151933, filed Sep. 4, 2024, which is hereby incorporated by reference herein in its entirety.

What is claimed is:

1. A fixing unit configured to fix a toner image on a recording material by heating the recording material with the toner image formed thereon, the fixing unit comprising:
a rotary member including a conductive layer and having a tubular shape extending in a longitudinal direction;
a coil configured to generate an alternating magnetic field to generate heat in the conductive layer; and
a core disposed inside the rotary member and configured to guide magnetic field lines of the alternating magnetic field,
wherein the core is constituted by a plurality of divided cores aligned along the longitudinal direction, and
at least one of the plurality of divided cores is formed in a columnar shape having an aspect ratio of 1:5 or less between a maximum width in a cross section orthogonal to the longitudinal direction and a length in the longitudinal direction, and is made of compacted magnetic core material disposed such that a hard-magnetization axis thereof is oriented in an intersection direction intersecting the longitudinal direction.

2. The fixing unit according to claim 1, wherein each of the plurality of divided cores is made of the compacted magnetic core material.

3. The fixing unit according to claim 1, wherein the compacted magnetic core material is formed in a cylinder shape having a circular cross section orthogonal to the longitudinal direction.

4. The fixing unit according to claim 1, wherein the compacted magnetic core material is formed in a prismatic cylinder shape having a rectangular cross section orthogonal to the longitudinal direction.

5. The fixing unit according to claim 1, wherein the coil is disposed inside the rotary member and includes a helical portion wound around a coil central axis extending along the longitudinal direction.

6. The fixing unit according to claim 5, wherein the core is longer than the helical portion in the longitudinal direction and protrudes from both ends of the helical portion.

7. The fixing unit according to claim 6, wherein the core and the helical portion are disposed across an entire heating region of the rotary member in the longitudinal direction.

8. The fixing unit according to claim 1, wherein the compacted magnetic core material is a compacted powder consisting of insulation-coated iron powder.

9. The fixing unit according to claim 1, wherein the rotary member is a film.

10. The fixing unit according to claim 1, further comprising a pressure roller that contacts the rotary member to form a fixing nip portion to heat and pressurize a recording material.

11. An image forming apparatus comprising:
an image forming unit configured to form a toner image on a recording material; and
the fixing unit according to claim 1.
